(19) United States
(12) Patent Application Publication
(10) Pub. No.: US 2004/0091671 A1
(43) Pub. Date: May 13, 2004

(54) Anti-slip glass fibre-reinforced plastic-plate

(76) Inventor: Joachim Worm, (US)

Correspondence Address: The H.T. Than Law Group, Suite 560, 1010 Wisconsin Ave., NW, Washington, DC, 20007, US

(21) Appl. No.: 10/699,915

(22) Filed: Nov. 3, 2003

(30) Foreign Application Priority Data
Nov. 4, 2002 (DE) DE 102 51 291.3

(51) Int. Cl. B32B 5/16; B32B 17/04; B32B 31/20; B32B 31/26

(52) U.S. Cl. 428/144; 156/247; 156/249; 156/298; 156/307.7; 264/112; 264/131; 428/150

(57) ABSTRACT

The invention relates to a glass fibre-reinforced plastic-plate which is provided with an anti-slip coating, consisting of resin and sand, as well as a production process of such a plate. The process according to the invention is a continuous one and does not require manual production steps. Initially, for the production a resin is bonded (10) with glass-fibre mats to a glass fibre-reinforced laminate as base material (20) and heated. As is conventional, the plate (20) is covered on both sides with carrier films (11, 12). In the subsequent phase of cooling-down (13) the point in time is waited for in which the plate (20) is in actual fact partly gelatinized, but the surface which is supposed to be coated is not yet completely cured. In this stage the upper carrier film (11) is pulled-off and a premixed coating compound consisting of resin and sand is applied (18) from above onto the base material (20). Alternative to the application of a premixed coating material, the resin and sand can be applied separately. Dissolver-vapours emerging at this stage can be drawn-off mechanically. In a circulating air drying oven (14) the heating-up to the final curing occurs.

### BACKGROUND OF THE INVENTION

1. Field of the Invention

This invention relates to a method for the production of a glass fibre-reinforced resin-plate which is coated with resin and sand and also to such a plate per se. With such a coating the surface of such a plate can obtain an anti-slip feature.

Such plates can be used as floors, for example, or, as the case may be, floorings in vehicles, particularly transport- and utility-vehicles. They can also be used as floors, or, again as the case may be, floorings in divers wet areas such as breweries, cold stores or slaughter houses.

2. Description of the Background Art

According to the prior art it is common that the here described plates are produced as follows: Initially a glass fibre-reinforced plastic-plate is produced in the known way and is subsequently fitted in the provided area. The plate, for example, and as already mentioned, is fitted in as a flooring in the loading area of a heavy goods vehicle. Subsequently a coating consisting of resin, which is supplied with glassmaking sand or corundum, is applied. For that purpose, firstly, a layer of synthetic resin is applied and then glassmaking sand or corundum material of different grain sizes is strewn-in, in said layer of resin. After rolling in the strewn-in material manually, said layer is sealed with more synthetic resin. Thus the application of the coating occurs manually. Said coating is then left to cure and solidify.

FIG. 1 illustrates a profile of a truck-flooring shown schematically in a sandwich composition. It consists of an upper glass fibre-reinforced plastic layer 1, a glass fibre-reinforced plastic bottom barrier 2, and an intermediate layer 3, which shows a variable structure depending on the manufacturer. The glass fibre-reinforced plastic layer 1 is generally glued onto the intermediate layer 3. In FIG. 1a, the upper glass fibre-reinforced plastic layer 1 is uncoated; in FIG. 1b said coating is supplied with an anti-slip surface 4 consisting of resin and sand.

The aforementioned production-technique is used, in particular, if said plates are required for comparatively large areas without grooves.

For further illustration it is shown in FIG. 2 schematically, how glass fibre-reinforced plastic plates without an anti-slip surface are usually produced according to the prior art in a continuous technique. Firstly resin, e.g. unsaturated polyester resin, is bonded in an area 10 with glass-fibre mats to a plate 20 and laminated. The plate 20 thereby moves to the right with reference to the plane of the figure as indicated by arrow 21. The top side of the plate 20 is covered by a backing-film 11, the bottom side with a backing-film 12. The curing of the plate 20 takes place between said backing-films 11 and 12.

In area 13 the plate 20 is heated-up to approximately 120° C. by heat addition (e.g. heating molds). Subsequently the plate 20 is then carried through a circulating air drying oven 14, having a temperature of approximately 125° C. for complete curing. After the plate 20 has left the circulating air drying oven 14, both backing-films 11 and 12 are pulled-off in area 15 and afterwards the plate 20 is fabricated.

As already described, the coating with resin and sand according to the prior art is carried out manually and is, in particular, not integrated in the described continuous method. Moreover, the described manufacturing method is comparatively pollutive to the environment, as vapours which appear during the coating-process are not drained off. Finally, it is a comparatively time-consuming and costly process.

A method for manufacturing a molded padding with a natural stone-like look is known from the German patent DE 197 33 810 C2. Thereby glass-fibre mats are applied on a basic form with resin again on top of it.

From the Japanese patent document JP 09 078 776 A, a floor-coating is known which shows a water-resistant coating of glass fibre-reinforced resin. This coating is covered again by a fireproof layer of glassmaking sand.

The purpose of the invention is to improve the known manufacturing methods for the described plates. In particular a continuous method is supposed to be disclosed which can be carried out mechanically. Furthermore, an environmentally friendlier method and better cost effectiveness is supposed to be achieved.

### SUMMARY OF THE INVENTION

According to the invention, the object is solved by the features stated in the independent patent claims. The dependent claims establish the essence of the invention in a particularly advantageous way.

According to the invention, the following steps for the manufacturing of a glass fibre-reinforced resin-plate covered with a mixture of resin and sand are made: In a first step a) resin, e.g. unsaturated polyester resin, with glass fibres, e.g. in form of a glass-fibre mat, is bonded to a plate-like substrate. This bonding is carried out by heating.

In a second step b) a cooling of the substrate takes place. Therewith it is important that the cooling occurs to a stage where the substrate is already partly dry on the one hand, but the surface, on the other hand, on which the coating is to be applied in the following, has not reached a completely hardened condition. Thus, in this stage the cross-linking of the resin with the glass fibres is not entirely completed.

The following step c) occurs in the stage described above, i.e. while the surface which is to be coated is not yet hardened. During this step the mixture of sand and resin is applied. The resin can be, for example polyester resin or also epoxy resin.

Finally in a following step d) the coated base material is heated in an oven, e.g. a circulating air drying oven, to effect the entire curing/cross-linking.

It is to be mentioned, in particular, that an advantage of the inventive procedure is that the procedure is continuous. Furthermore, it can be carried-out without manual steps.

It is particularly advantageous that the same type of resin is used for the manufacturing of the base material and the coating material. Due to that, the bonding between the coating and the plate occurs through a consistent cross-linking and curing.

Advantageously, the vapours which emerge during the curing are drawn off mechanically. Due to that, it is possible to make the procedure more environmentally acceptable, compared with the prior art procedure. The dissolver can be for example styrene.

In step d) radical donors (peroxides) are added for the curing.

The cooling-down in step b) occurs advantageously to a temperature range between 50° C. and 90° C., e.g. approximately 70° C.

The cooling in step b) can be realized advantageously by addition of cooling air or another cooling fluid.

The temperature in the oven stays advantageously in a range between 105° C. and 145° C., e.g. at around 125° C.

By using carrier films it is advantageous in step b) that the carrier film, which covers the surface that is to be coated, is pulled-off from the base material (Oust) before the mixture for the coating is applied, thus just before step c). By this means, the area where vapours are emitted to the environment can be kept relatively small.

According to a further aspect of the invention, the following steps are carried out for manufacturing a glass fibre-reinforced resin-plate, coated with a mixture of resin and sand: In a first step a) resin, e.g. unsaturated polyester resin is bonded with glass filaments, e.g. in form of a glass-fibre mat to a plate-like base material. This bonding occurs by heating.

In a second step b) a cooling-down of the base material occurs. Thereby it is again important that the cooling-down occurs to a point, where the base material is already gelatinized but the surface, on which the coating is to be applied in the following, has not completely reached a cured condition.

The following step c) occurs in the above described stage, where the surface which is to be coated is not completely solid. In this stage resin is applied. The resin can again be, for example, polyester resin or also epoxy resin. In a following step d) sand is applied and subsequently rolled-in in step e).

This step can be realized as a part of a continuous manufacturing process.

Finally in a following step f) the coated base material is heated in an oven, for example, a circulating air drying oven.

During the application of the coating material, it is also possible to apply the sand first and subsequently the resin.

For the procedure according to this aforementioned aspect of the invention, the same advantages result as for the procedure descibed in the first aspect. Also in relation to the temperature ranges, as to the supply of cooling air and radical donors and the pulling-off of the carrier film, as also to the usage of the resin type, the details shown under the first aspect apply in equal measure.

Further features, advantages and particularities will become evident by means of a detailed description of an embodiment and reference to the figures of the accompanying drawings.

### BRIEF DESCRIPTION OF THE DRAWINGS

FIG. 1 shows a cross-section schematic through a truck-floor in sandwich construction (prior art),

FIG. 2 shows a schematic depiction of the procedure of a fibre glass-reinforced plate according to the prior art, and

FIG. 3 shows a schematic depiction of a procedure of a plastic plate according to the present invention.

### DESCRIPTION OF THE PREFERRED EMBODIMENTS

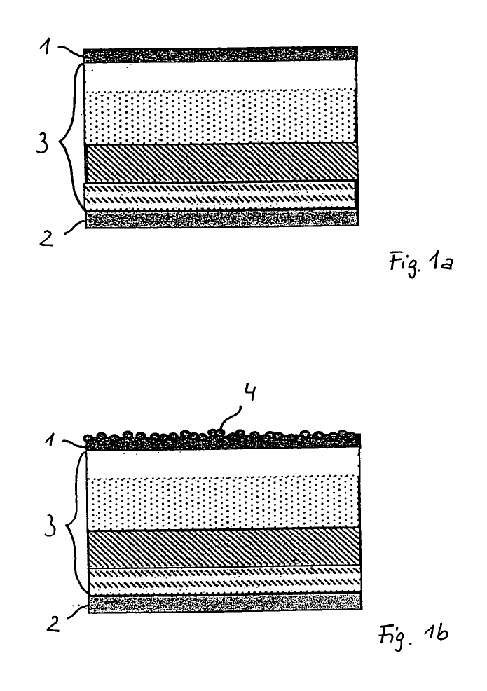

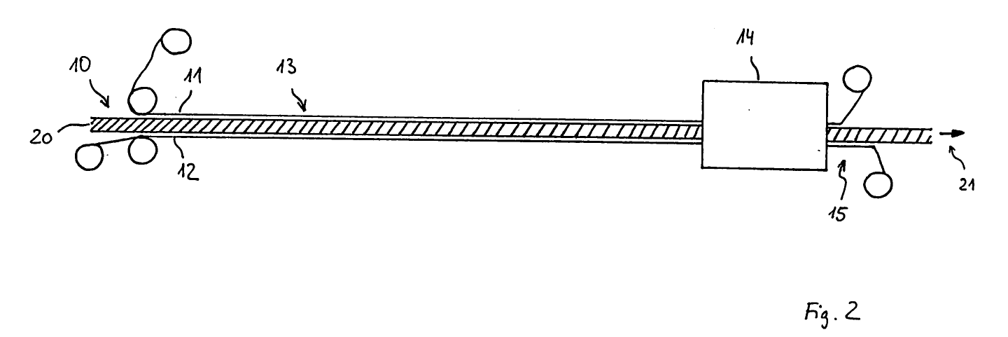

FIG. 2 has already been referred to above. In this figure, the procedure of manufacturing a glass fibre-reinforced plastic plate according to the prior art, is shown schematically. Such plates are used, for example, as floorings in transport vehicles. The construction of such floors is shown schematically in FIG. 1. This has also been referred to above.

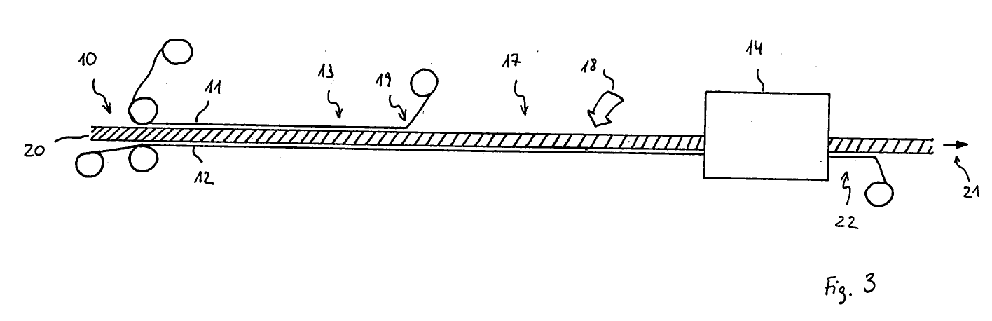

FIG. 3 shows the process manufacturing a plate according to the here described embodiment of the present invention, schematically. The reference characters used in FIG. 2 and FIG. 3, respectively, have the same meaning.

As is recognized in FIG. 3 at the beginning of the process according to the present invention, resin e.g. unsaturated polyester resin—in the area 10—is bonded and laminated to a plate 20. The thickness of the plate may range from, for example, 0.8 to 5 mm.

Referring to the width of the plate (upright to the plane of the drawing in FIG. 3) no limits are predetermined in principle. Widths of up to four meters can be attained for example.

The plate 20 is transported to the right in the plane figure, as indicated by the arrow 21 in FIG. 3. The speed of this movement is to be chosen inter alia depending on the thickness of the plate. The thicker the plate, the slower transport-speed is usually chosen. For example, transport-speeds in a range of approximately 100 to 120 meters per hour can be reached.

The surface of the plate 20 is covered with a carrier film 11, the bottom side with a carrier film 12. The carrier films 11 and 12 can be made of, for example, polyester.

In the area 13, the plate 20 is heated through heat addition (e.g. heat molding) up to approximately 120° C. The plate 20 now describes a fibre glass-reinforced plastic-laminate.

At point 19, the upper carrier film 11 is pulled-off prematurely according to FIG. 2, compared to the process of the prior art.

In area 17, a cooling-down of the plate 20 to approximately 70° C. follows. Through this cooling-down, the chemical reaction by which the cross-linking of the materials of the plate 20 occur, is slowed-down or interrupted. Cooling air can be supplied at this point as an aid to the acceleration, as the case may be, of the cooling-down process.

The length of this cooling-down section between point 19, where the upper carrier film 11 is pulled-off, and the following circulating air drying oven 14 can, for example, add up to approximately five to six meters. The length of the section depends on the thickness of the plate 20 inter alia.

Before the plate 20 is run-into the circulating air drying oven 14, it is covered with a mixture of resin and sand as shown in FIG. 3 through the bold arrow 18, as a symbolic depiction.

It is critical that at the point of the coating process 18, the plate 20 is not yet completely cross-linked and in particular that the surface of the plate 20, on which the coating is to be applied, is not yet in a completely hardened phase. The length of the cooling-down section, the transport-speed of the plate, and the temperature conditions, in total, are thus accordingly chosen and co-ordinated.

The mixture, consisting of resin and sand that is to be applied is, according to this embodiment, a premixed coating compound. The resin can be, for example, polyester resin or epoxy-resin. According to this embodiment, preferably the same resin type is utilized which is also used for the above-described process of the plate in connection with the glass-fibre mats, thus for example, polyester resin.

The sand, e.g. in form of quarry sand, may show different grain sizes. Thereby no limits are given for the choice of the grain sizes in principle. Grain sizes, for example, in the range of 0.3 to 7 mm cross section can be used.

The application of the coating compound can follow, for example, by doctor blading with the help of a doctor blade pan.

The coating material is applied in a predetermined amount. The thickness of the coating in a wet condition can be approximately 1.2 mm, for example, in a dry condition in this case a coating thickness of approximately 800 to 900 μm is reached.

Alternatively, it is possible to apply the coating by applying firstly resin on the not-completely hardened surface of plate 20 e.g. through doctor blading and subsequently by applying the sand which is rolled-in by means of, for example, a vibrating roller.

In area 17, where thus the upper carrier film 11 is already pulled-off, vapours emerge by the curing of the synthetic resin which affect the environment, and which contain the respective dissolver, e.g. styrene (phenylethylene styrene). These vapours are drawn-off mechanically. Over a post-combustion chamber, the vapours can be disposed in an environmentally-acceptable manner. This describes a decisive advantage when compared to the prior art, where a drawing off of the dissolver-vapours is not provided, because the plate is finally assembled during the coating.

Subsequently the coated plate 20 is transported through an oven 14 for final curing, e.g. a circulating air drying oven 14, which has a temperature of approximately 125° C. Here the radical donors are supplied (peroxides) appropriately selected in order to support the cross-linking of the plate 20 with the coating material.

If, as described above, the same type of resin is used for the production of the plate as well as for the coating material, the coating material is completely bonded with the resin of the base material on the surface of the plate 20 and cross-linked and cured as a unity.

After the plate 20 has left the circulating air drying oven 14, the lower carrier film 12 is pulled-off in the area 22 and, subsequently, the plate 20 is fabricated.

The completed plate can be further processed as cut-to-size or in rolls, and, as such, can be fitted-in as flooring in a utility-vehicle.

Considering the content of the dissolver in the completed plate, styrene values under 2% preferably under 1.5% are achievable by using the process according to this embodiment. Contrary values in the range of approximately 2 to 3.5% of the content of residual styrene are achieved using the initially described manual process, according to the prior art.

The content of residual styrene depends on the extent of the cross-linking of the fabricated plate: The higher the extent of the cross-linking, the lower the value of the content of residual styrene.

The content of the residual styrene of the plate changes insignificantly after the finishing of the fabrication process. Therefore, many years after the production of the plate similar values of the content of the residual styrene can also be expected, which the plate shows directly after the termination of the fabrication process.

The advantages of the invention can be summarized as follows:

For the first time a continuous process for the production of a glass fibre-reinforced plastic plate covered with resin/sand is presented, which makes manual production steps superflous.

The process according to the invention distinguishes itself, compared to the process of such plates according to the prior art, by an increased environmental acceptability because the dissolver-vapours can be drawn-off.

The process according to the invention distinguishes itself, compared to the production of such plates according to the prior art, by an increased economic efficiency, because, no manual steps are necessary.

The bondage between the coating and the plate occurs, contrary to the prior art, by cross-linking and curing as a unity.

### LIST OF REFERENCE CHARACTERS

1 Upper glass fibre-reinforced plastic layer

2 Glass fibre-reinforced plastic bottom barrier

3 Intermediate layer

4 Anti-slip coating made of resin and sand

5 Area in which resin is bonded with glass-fibre mats

6 Upper carrier film

7 Lower carrier film

8 Area of mold heaters

9 Circulating air drying oven

10 Area in which both carrier films 11 and 12 are pulled off

11 Area in which the coating is applied

18 Application of the coating

19 Pulling-off of the upper carrier film

20 Plate

21 Transporting direction of the plate

22 Pulling-off of the lower carrier film

We claim:

1. A process for a continuous production of a glass-fibre reinforced resin-plate coated with a mixture of resin and sand, comprising the following steps:
a) bonding of resin and glass fibres by heating to a plate-like base material,
b) cooling-down of the base material until the base material is partly gelatanized, but the surface of the base material which is to be coated, is not yet completely hardened,
c) applying of the mixture of resin and sand on the not-yet hardened surface which is to be coated, and
d) heating of the base material, coated in such a manner, in an oven.

2. The process according to claim 1, characterized in
that the same resin type is used in steps a) and c).

3. The process according to claim 1, characterized in
that vapours which emerge during the steps are drawn-off.

4. The process according to claim 1, characterized in
that radical donors are supplied in step d) which cause a cross-linking of the base material with the mixture of resin and sand.

5. The process according to claim 1, characterized in
that in step b) the base material is cooled-down to a temperature in a range between 50° C. and 90° C.

6. The process according to claim 1, characterized in
that a cooling-fluid is supplied in step b).

7. The process according to claim 1, characterized in
that the coated base material is heated to a temperature in the range of 105° C. to 145° C. in step d).

8. The process according to claim 1, characterized in
that the base material on the surface that is to be coated is covered with a film in step b) and that this film is pulled-off from the base material before step c).

9. A process to manufacture a glass-fibre reinforced resin-plate coated with resin and sand, comprising the following steps:
a) bonding of resin and glass fibres by heating to a plate-like base material,
b) cooling-down of the base material until the base material partly gelatinizes, but the surface of the base material, which is to be coated, has not yet completely hardened,
c) applying of the resin onto the partly gelatinised surface which is to be coated,
d) applying of sand on the not-yet hardened surface which is to be coated,
e) rolling-in of the sand in the resin layer applied in step c), and
f) heating of the base material coated in such a manner in an oven.

10. The process according to claim 9, characterized in
that the steps are carried out in the sequence a), b), d), c), e), f).

11. The process according to claim 9, characterized in
that the same resin type is used in steps a) and c).

12. The process according to claim 9, characterized in
that vapours which emerge during the processing steps are drawn-off.

13. The process according to claim 9, characterized in
that radical donors are supplied in step d), which cause a cross-linking of the base material with the mixture consisting of resin and sand.

14. The process according to claim 9, characterized in
that the base material is cooled down to a temperature in a range between 50° C. and 90° C. in step b).

15. The process according to claim 9, characterized in
that in step b) a cooling-fluid is supplied.

16. The process according to claim 9, characterized in
that the coated base material is heated to a temperature in the range of 105° C. to 145° C. in step f).

17. The process according to claim 9, characterized in
that in step b) the base material is covered by a film on the surface that is to be coated and this film is pulled-off from the base material before steps c) and d).

18. A Glass-fibre reinforced resin-plate with an anti-slip coating of resin and sand, produced by a process according to claim 1, whereby the content of residual styrene is less than 2%, preferably less than 1.5%.

19. A Glass-fibre reinforced resin-plate with an anti-slip coating of resin and sand, produced by a process according to claim 9, whereby the content of residual styrene is less than 2%, preferably less than 1.5%.
